(19) United States
(12) Patent Application Publication
(10) Pub. No.: US 2019/0265206 A1
(43) Pub. Date: Aug. 29, 2019

(54) SYSTEMS, METHODS AND DEVICES FOR CROSS-STREAM INJECTION CHROMATOGRAPHY

(71) Applicant: Waters Technologies Corporation, Milford, MA (US)

(72) Inventor: Abhijit Tarafder, Franklin, MA (US)

(73) Assignee: Waters Technologies Corporation, Milford, MA (US)

(21) Appl. No.: 15/769,220

(22) PCT Filed: Oct. 19, 2016
(86) PCT No.: PCT/US16/57612

§ 371 Date: Apr. 18, 2018

Related U.S. Application Data
(60) Provisional application No. 62/243,770, filed on Oct. 20, 2015.

(51) Int. Cl. G01N 30/20

(52) U.S. Cl. CPC G01N 30/20; G01N 2030/347; G01N 2030/207

(57) ABSTRACT

A significant reduction in extra-column band broadening can be achieved by decoupling the injection system from the main solvent flow line. Systems and methods for such decoupling can allow for the injection of larger volumes of sample without compromising separation yield, increase the column loading per batch, and increase the overall yield of separations. For example, a mixture of co-solvent and sample can be prepared separately from the main flow of mobile phase and co-solvent (e.g., a mixture of CO₂ and methanol), loaded onto an injection loop, and then injected directly into the main flow of mobile phase and co-solvent before the chromatography column.

### CROSS-REFERENCE TO RELATED APPLICATION

This application claims the benefit of and priority to U.S. Provisional Application No. 62/243,770, filed Oct. 20, 2015, and entitled “Systems, Methods and Devices for Cross-Stream Injection Chromatography.”

### FIELD OF THE INVENTION

The present invention generally relates to chromatography systems, and in particular, systems, methods and devices for reducing extra-column band broadening in highly-compressible fluid chromatography (e.g., CO₂-based chromatography).

### BACKGROUND

Highly-compressible fluid chromatography is a type of chromatography that is configured to operate with a solvent that includes a fluid (e.g., carbon dioxide, Freon, etc.) that is in a gaseous state at ambient/room temperature and pressure. Typically, highly-compressible fluid chromatography involves a fluid that experiences noticeable density changes over small changes in pressure and temperature. Although highly-compressible fluid chromatography can be carried out with several different compounds, in the current document CO₂ will be used as the reference compound as it is currently the most commonly employed. (It is noted that highly-compressible fluid chromatography has also been referred to as CO₂-based chromatography, or in some instances as supercritical fluid chromatography (SFC), especially where CO₂ is used as the mobile phase. It is also noted that, in this application, mobile phase is used as a term to describe the primary source of a combined flow stream flowing through a chromatography column. For example, in a separation in which CO₂ and methanol (a co-solvent) are mixed together to create a combined flow stream passing through a chromatography column, the term mobile phase will refer to the CO₂ and the methanol will be referred to as a co-solvent.)

Highly-compressible fluid chromatography combines many of the features of liquid chromatography (LC) and gas chromatography (GC), and can often be used for separations with compounds that are not suitable either for LC or GC. For example, CO₂-based chromatography can be advantageous for separation and analysis of hydrophilic and chiral compounds, lipids, thermally-labile compounds and polymers. Other advantages include the lower cost and toxicity of the mobile phase, when using CO₂ as a solvent, compared to many liquid mobile phases typically used in LC.

In addition to carbon dioxide, the mobile phase fluid typically contains a liquid organic co-solvent mixed together with the carbon dioxide. A common co-solvent is methanol. Examples of other co-solvents include acetonitrile and alcohols such as ethanol and isopropanol. The carbon dioxide based mobile phase (including any co-solvent) is maintained at a pressure and temperature where the mobile phase remains as a homogeneous, single phase. To do so, systems must be able to provide and maintain tight control over temperature, pressure, etc.

Two of the factors that influence the separation power of any chromatographic system are the separation factor or selectivity of the separation media and the efficiency of the system. The efficiency of a chromatography system is affected by the band broadening or band dispersion produced by the system. The terms “band broadening” and “band dispersion” are used interchangeably herein. Higher selectivity provides improved separation. Brand broadening negatively affects separation. As a result, a reduction in band broadening will improve the separation power of an instrument.

Extra-column band broadening (i.e., band broadening contributed to system components lying outside of the column) can occur in a chromatography system due to various factors. For example, upstream of the column, dispersion can occur after the band leaves the injector, while it is traveling towards the column inlet. An ideal sample leaves the injector as a rectangular band 10 in a conduit 12, e.g., as shown in FIG. 1A. After the sample band leaves the injector, the band is transported from the injector to the column inlet. The diffusivity of analytes in the mobile phase controls dispersion while the band travels along the tubing connecting the injector to the column inlet. For example, FIG. 1B illustrates a diffused sample band 14 in a conduit 12. Analyte diffusivity in typical SFC solvents, such as CO₂, is significantly greater than in the solvents used in conventional LC, which could result in a diffused band at the column inlet. Another factor that can affect dispersion inside the column is a mismatch between the composition of the sample solvent and the mobile phase. For example, severe band distortion leading to separation loss can take place if a sample is prepared in a solvent having a composition markedly different than the composition of the mobile phase. (See, for example, Mishra M, Rana C, De Wit A, Martin M., Influence of a strong sample solvent on analyte dispersion in chromatographic columns, J Chromatogr. A. 2013 Jul. 5;1297:46-55.) Another factor that can lead to band broadening is additional volume to a system outside the column, i.e., adding multiple fluidic lines, components (e.g., mixers) or connectors.

In conventional CO₂-based chromatography preparative systems, there are two commonly used techniques for injecting sample/feed solution into the mobile stream. (See, for example, Arvind Rajendran, Design of preparative supercritical fluid chromatography, J Chromatogr. A., 2012 Jun. 7; 1250:227-249.) The first conventional technique, which is also commonly used in HPLC, injects the feed solution directly into the CO₂ plus co-solvent/modifier mixture. That is, the feed solution is injected into the main mobile phase fluid line after mixing the CO₂ and co-solvent together but before the column. This technique, however, can lead to significant distortion of the chromatographic band even when injecting moderate volume of the feed solution. This is because the solvent used to prepare the feed solution can only be the modifier, leading to significant mismatch in feed solvent versus mobile phase composition. The second technique, which is used to address mismatch, is to inject the sample directly into the modifier before the modifier is mixed with the CO₂. This technique has some limitations due to problems associated with mixing of the sample/feed solution with co-solvent. That is, the mixing process can significantly distort the feed band profile, resulting in extra-column band dispersion. And this can lead to overlapping peaks inside the column resulting in yield loss, especially if the target compound(s) have closely eluting impurities.

Accordingly, there remains a need for sample injection mechanisms that reduce extra-column band broadening.

### SUMMARY

A significant reduction in extra-column band broadening can be achieved by decoupling the injection system from the main solvent flow line. Systems and methods for such decoupling can allow for the injection of larger volumes of sample without compromising separation yield, increase the column loading per batch, and increase the overall yield of separations. That is, by removing (e.g., decoupling) sample injection from the main mobile phase flow line, extra-column band dispersion is reduced. The sample can be injected with the use of an additional flow line eliminating undesirable constraints on sample size. While adding extra volume to a highly-compressible fluid chromatography system is typically avoided in the art, the inventors have surprisingly found that by decoupling column loading and column injection by having dedicated flow lines, extra-column band broadening can be reduced.

One aspect provides a chromatography system including a first fluid delivery system, a second fluid delivery system, a sample loop, a chromatography column, and a valve. In exemplary embodiments, the first fluid delivery system includes a first co-solvent source and a first mobile phase source and the second fluid delivery system includes a second co-solvent source and a second mobile phase source. In some embodiments, the second co-solvent source provides a co-solvent and a sample dissolved in the co-solvent. The valve has, i.e., can be disposed in, a plurality of discrete positions forming different fluidic connections. In exemplary embodiments, the plurality of discrete positions can include a first position in which the first fluid delivery system is in fluid communication with the chromatography column and the second fluid delivery system is in fluid communication with the sample loop and a second position in which the first fluid delivery system is in fluid communication the sample loop and the sample loop is in fluid communication with the chromatography column.

In exemplary embodiments, the relative concentrations of co-solvent and mobile phase provided by the first fluid delivery system can be the same as the relative concentrations of co-solvent and mobile phase provided by the second fluid delivery system. In other embodiments, the relative concentrations of co-solvent and mobile phase provided by the first fluid delivery system can be different from the relative concentrations of co-solvent and mobile phase provided by the second fluid delivery system. For example, the concentration of co-solvent provided by the second fluid delivery system can be higher than the concentration of co-solvent provided by the first fluid delivery system. In some embodiments, the relative concentrations of co-solvent and mobile phase provided by one or both of the first fluid delivery system and the second fluid delivery system can be variable over an elution period or fraction thereof (e.g., gradient mode).

Another aspect provides chromatography system including a first co-solvent source in fluid communication with a first mixer, a second co-solvent source in fluid communication with a second mixer, a mobile phase source configured to provide mobile phase to the first and second mixers, a sample loop, a chromatography column, and a valve. In some embodiments, the second co-solvent source provides a co-solvent and a sample dissolved in the co-solvent. The valve has, i.e., can be disposed in, a plurality of discrete positions forming different fluidic connections. In exemplary embodiments, the plurality of discrete positions forming different fluidic connections can include a first position in which the first mixer is in fluid communication with the chromatography column and the second mixer is in fluid communication with the sample loop and a second position in which the first mixer is in fluid communication the sample loop and the sample loop is in fluid communication with the chromatography column.

In exemplary embodiments, the relative concentrations of co-solvent and mobile phase from the first mixer can be the same as the relative concentrations of co-solvent and mobile phase from the second mixer. In other embodiments, the relative concentrations of co-solvent and mobile phase from the first mixer can be different from the relative concentrations of co-solvent and mobile phase from the second mixer. For example, the concentration of co-solvent from the second mixer can be higher than the concentration of co-solvent from the first mixer. In some embodiments, the relative concentrations of co-solvent and mobile phase from one or both of the first mixer and the second mixer can be variable over an elution period or fraction thereof.

A further aspect provides a method including pressurizing a first flow path through a valve to a chromatography column with a first mixture of mobile phase and co-solvent, pressurizing a second flow path through the valve to a sample loop with a second mixture of mobile phase and co-solvent, and actuating the valve to introduce the second mixture of mobile phase and co-solvent in the sample loop into the chromatography column. The second mixture mobile phase and co-solvent can further includes a sample dissolved in the co-solvent.

In some embodiments. the relative concentrations of co-solvent and mobile phase in the first mixture of mobile phase and co-solvent is the same as the relative concentrations of co-solvent and mobile phase in the mixture of mobile phase and co-solvent. In other embodiments, the relative concentrations of co-solvent and mobile phase in the first mixture of mobile phase and co-solvent is different from the relative concentrations of co-solvent and mobile phase in the mixture of mobile phase and co-solvent. For example, the concentration of co-solvent in the second mixture can be higher than the concentration of co-solvent in the first mixture.

In exemplary embodiments of the above aspects, the mobile phase can be CO₂. In some embodiments, the CO₂ can be in a supercritical state or a substantially supercritical state. In certain embodiments, the CO₂ is in a subcritical state. The co-solvent can be a polar or non-polar organic solvent selected from the group consisting of but not limited to methanol, ethanol or isopropanol, acetonitrile, acetone, tetrahydrofuran, and mixtures thereof (including mixtures of water and any of these solvents). Some embodiments can include a gas liquid separator, wherein the second fluid delivery system, the second co-solvent source, or the second mixture of mobile phase and co-solvent is in fluid communication with the gas liquid separator through the valve in one or both of the first and second valve positions.

### BRIEF DESCRIPTION OF THE DRAWINGS

The invention will be more fully understood from the following detailed description taken in conjunction with the accompanying drawings, in which:

FIG. 1A illustrates a ideal sample band;

FIG. 1B illustrates a diffused sample band;

FIG. 2 schematically illustrates a prior art method of sample injection;

FIG. 3 schematically illustrates another prior art method of sample injection;

FIG. 4 schematically illustrates a sample injection system according to an embodiment of the present invention;

FIG. 5 schematically illustrates another sample injection system according to an embodiment of the present invention;

FIG. 6 schematically illustrates a further sample injection system according to an embodiment of the present invention.

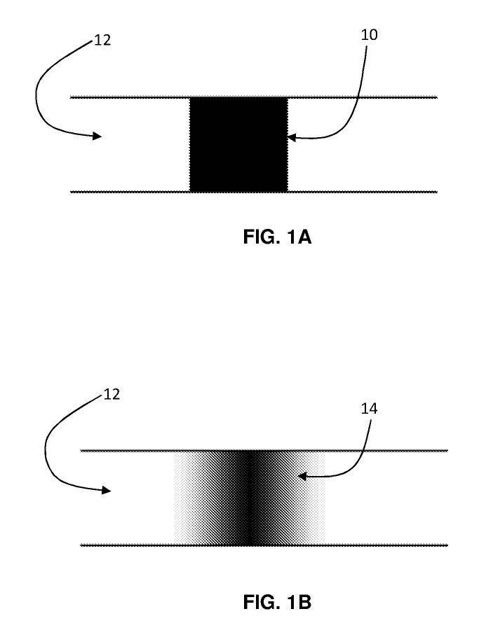

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

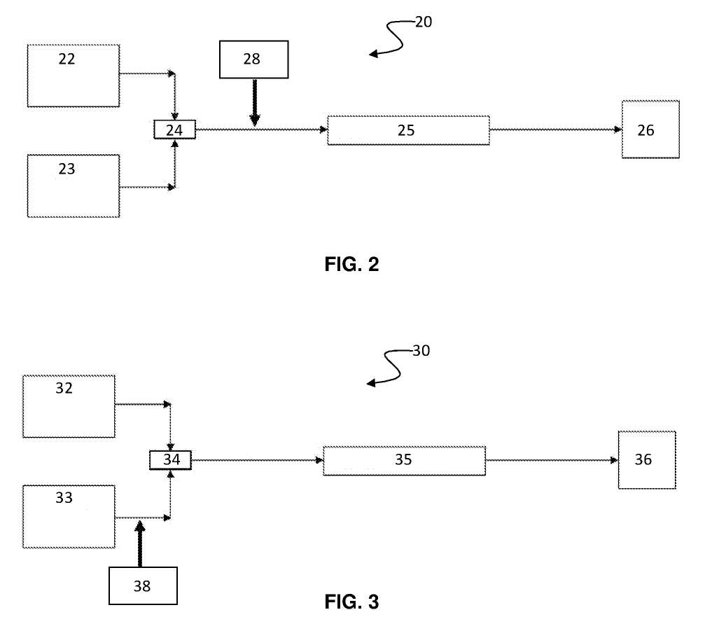

FIG. 2 illustrates one system for injecting sample solution into a mobile phase stream. FIG. 2 schematically illustrates a chromatography system 20 including a mobile phase source 22, a co-solvent source 23, a mixing connector 24, and a chromatography column 25. The mobile phase source 22 supplies mobile phase, e.g., CO₂ and the co-solvent source 23 supplies a co-solvent, e.g., methanol, to the mixing connector 24. The mixing connector 24 mixes the co-solvent and mobile phase. The co-solvent and mobile phase mixture then passes from the mixing connector 24 to a chromatography column 25. After passing through the chromatography column 25, the mixture of mobile phase and co-solvent flows to a detector 26. As shown in FIG. 2, the method includes injecting a feed solution 28 including solvent and sample directly into the mobile phase and co-solvent mixture after the mixing connector 24. This method can lead to significant distortion of the chromatographic band even when injecting moderate volume of the feed solution because the solvent used to prepare the feed solution may not be the same as the composition of the mobile phase, which results in a mismatch between the feed solvent and the mobile phase composition. In CO₂-based or other highly-compressible fluid chromatography, this mismatch is inevitable because the mobile phase is a mixture of compressible CO₂ and liquid organic co-solvent, but the sample is prepared in a liquid solvent. If the eluting strength of the sample solvent is greater than that of the mobile phase, a deformation of the analyte zone occurs because its frontal part moves at a relatively high velocity due to a low retention factor in the sample solvent while the rear part of the analyte zone is more retained in the mobile phase liquid and hence moves at a lower velocity.

FIG. 3 illustrates another injection system for injecting sample solution into the mobile phase stream. FIG. 3 schematically illustrates a chromatography system 30 including a mobile phase source 32, a co-solvent source 33, a mixing connector 34, and a chromatography column 35. The mobile phase source 32 supplies mobile phase, e.g., CO₂ and the co-solvent source 33 supplies a co-solvent, e.g., methanol, to the mixing connector 34. The mixing connector 34 mixes the co-solvent and mobile phase. The co-solvent and mobile phase mixture then passes from the mixing connector 34 to a chromatography column 35. After passing through the chromatography column 35, the mobile phase/co-solvent flows to a detector 36. As shown in FIG. 3, the method includes injecting the sample 38 directly into the co-solvent stream from the co-solvent source 33 before mixing the co-solvent with the mobile phase. Injecting the sample directly into the co-solvent stream alleviates the mismatch between the feed solution and the mobile phase composition, allowing larger sample volume to be injected into the system for separation. However, this injection mechanism has other limitations, especially when separating closely eluting components. For example, problems can arise because the co-solvent and sample are mixed with the mobile phase after the sample is introduced into the system. The mixing process can significantly disperse the sample band, resulting in high extra-column band dispersion. This, in turn, can lead to peak overlapping inside the column resulting in yield loss, especially if the target compound(s) have closely eluting impurities. Another problem related to this injection mechanism is the dependence of the mass of sample injected per injection, on the co-solvent composition. If the co-solvent percent is low in the modifier stream, either one has to accept lower mass injection into the system or longer injection time—both of which leads to loss of productivity and separation performance.

In exemplary embodiments, a significant reduction in extra-column band broadening can be achieved by decoupling the injection system from the main solvent flow line. Systems and methods for such decoupling can allow for the injection of larger volumes of sample without compromising separation yield, increase the column loading per batch, and increase the overall yield of separations. For example, a mixture of co-solvent and sample can be prepared separately from the main flow of mobile phase and co-solvent, loaded onto an injection loop, and then injected directly into the main flow of mobile phase and co-solvent just before the chromatography column.

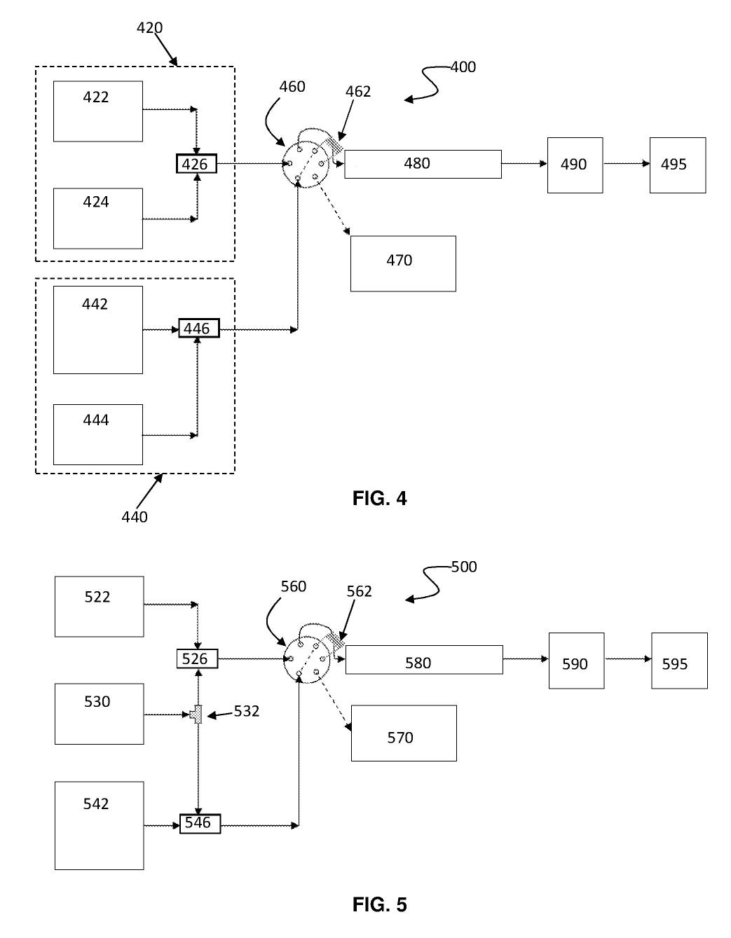

FIG. 4 illustrates an exemplary chromatography system 400. The system includes a first fluid delivery system 420, a second fluid delivery system 440, a valve 460, and a chromatography column 480. The valve 460 can include or be in fluid communication with a sample loop 462. In some embodiments, a detector 490 and a back pressure regulator 495 can be downstream of the column 480.

In exemplary embodiments, the first fluid delivery system 420 can include a first co-solvent source 422, a first mobile phase source 424, and a first mixing connector 426 (e.g., a mixer). The second fluid delivery system 440 can include a second co-solvent source 442, a second mobile phase source 444, and a second mixing connector 446. The second co-solvent source 442 can be the sample source. For example, the second co-solvent source can provide co-solvent and a sample dissolved in the co-solvent. The relative concentrations of co-solvent and mobile phase provided by the first fluid delivery system 420 can be the same as the relative concentrations of co-solvent and mobile phase provided by the second fluid delivery system 440. In other embodiments, the relative concentrations of co-solvent and mobile phase provided by the first fluid delivery system 420 can be different from the relative concentrations of co-solvent and mobile phase provided by the second fluid delivery system 440. By decoupling the second fluid delivery system 440 from the first fluid delivery system 420, an operator has a multitude of concentration possibilities. That is, one is no longer constrained by the co-solvent concentration selected or required for conditioning a column for separation. Numerous possibilities regarding co-solvent concentration are now possible. For example, the concentration of co-solvent provided by the second fluid delivery system 440 can be higher than the concentration of co-solvent provided by the first fluid delivery system 420. In some embodiments, the relative concentrations of co-solvent and mobile phase provided by one or both of the first fluid delivery system 420 and the second fluid delivery system 440 can be variable over an elution period or fraction thereof (e.g., gradient mode).

The valve 460 can be a multi-port rotary shear seal valve having a plurality of fluidic ports and one or more flow-through conduits. Although described primarily as a rotary valve, other types of suitable valves can also be used including, but not limited to, slider valves, solenoids, and pin valves. Each flow-through conduit provides a pathway between a pair of neighboring fluidic ports. When the valve rotates, its flow-through conduits move clockwise or counterclockwise, depending upon the valve's direction of rotation. This movement operates to switch the flow-through conduit to a different of neighboring fluidic ports, establishing a fluidic pathway between that different pair while removing the pathway from the previously connected pair of fluidic ports.

The valve 460 can be placed in a plurality of discrete positions. For example, those positions can include a first position corresponding to a LOAD state of the valve and a second position corresponding to an INJECT state of the valve. In the LOAD state, the first fluid delivery system 420 is in fluid communication with the chromatography column 480 while the second fluid delivery system 440 is in fluid communication with the sample loop 462. In the INJECT state, the first fluid delivery system 420 is in fluid communication the sample loop 462 and the sample loop 462 is in fluid communication with the chromatography column 480.

When in the LOAD state, the first fluid delivery system can deliver mobile phase or a mixture of mobile phase and a co-solvent to the column. In such embodiments, the first fluid delivery system can include a first co-solvent source 422 and a first mobile phase source 424. When in the LOAD state, the second fluid delivery system 440 can deliver co-solvent or a mixture of co-solvent and a sample dissolved therein to the sample loop 462. In some embodiments, the second fluid delivery 440 can provide flow to the sample loop 462 until a pre-set pressure in the sample loop 462 is reached. For example, the pre-set pressure can be the same as the system pressure of the first fluid delivery system.

In other embodiments, the second fluid delivery system 440 can provide continuous flow through the sample loop 462 in the LOAD state. In such embodiments, the valve 460 can be configured to place the sample loop 462 in communication with a gas/liquid separator 470 in the LOAD state. The gas/liquid separator is configured to separate the co-solvent or mixture of co-solvent and sample from the mobile phase, e.g., CO₂. In such embodiments, the gas liquid separator 470 can be in fluid communication with the second fluid delivery system 440, e.g., with the second co-solvent source 442. In other embodiments, flow from the second fluid delivery system 440 through the sample loop 462 can pass to a waste container. While FIG. 4, shows a gas/liquid separator 470 connected to valve 460, other types of recycling mechanisms known in the art can be substituted for the gas/liquid separator to capture and recycle at least a portion of the mobile phase.

When in the INJECT state, the first fluid delivery system delivers mobile phase or a mixture of mobile phase and a co-solvent first through the sample loop and then into the column, injecting the contents of the sample loop onto the column. When in the INJECT state, flow from the second fluid delivery system 440 can be directed to the gas liquid separator 470 (for collection or re-cycling of the sample) or to waste.

FIG. 5 illustrates another exemplary chromatography system 500. The system illustrated in FIG. 5 includes a single mobile phase source 530. The mobile phase source 530 provides mobile phase to a first mixing connector 526 and a second mixing connector 546, e.g., via a flow controller 532. The system 500 includes a first co-solvent source 522, a second co-solvent source 542, a valve 560, and a chromatography column 480. The valve 560 can include or be in fluid communication with a sample loop 562. The first co-solvent source 522 can be in fluid communication with the first mixing connector 526. The second co-solvent source 542 can be in fluid communication with the second mixing connector 546. The relative concentrations of co-solvent and mobile phase provided from the first mixing connector 526 can be the same as the relative concentrations of co-solvent and mobile phase provided from the second mixing connector 546. In other embodiments, the relative concentrations of co-solvent and mobile phase provided from the first mixing connector 526 can be different from the relative concentrations of co-solvent and mobile phase provided from the second mixing connector 546. For example, the concentration of co-solvent provided from the second mixing connector 546 can be higher than the concentration of co-solvent provided from the first mixing connector 526. In some embodiments, the relative concentrations of co-solvent and mobile phase provided from one or both of the first mixing connector 526 and the second mixing connector 546 can be variable over an elution period or fraction thereof.

In exemplary embodiments, the second co-solvent source 442 can be the sample source. For example, the second co-solvent source can provide co-solvent and a sample dissolved in the co-solvent. In certain embodiments the sample can be injected or contained directly into the sample loop 562. In some embodiments, a detector 590 and a back pressure regulator 595 can be downstream of the column 580.

The valve 560 can be a multi-port rotary shear seal valve having a plurality of fluidic ports and one or more flow-through conduits. Although described primarily as a rotary valve, other types of suitable valves can also be used including, but not limited to, slider valves, solenoids, and pin valves. Each flow-through conduit provides a pathway between a pair of neighboring fluidic ports. When the valve rotates, its flow-through conduits move clockwise or counterclockwise, depending upon the valve's direction of rotation. This movement operates to switch the flow-through conduit to a different pair of neighboring fluidic ports, establishing a fluidic pathway between that different pair while removing the pathway from the previously connected pair of fluidic ports.

The valve 560 can be placed in a plurality of discrete positions. For example, those positions can include a first position corresponding to a LOAD state of the valve and a second position corresponding to an INJECT state of the valve. In the LOAD state, the first mixer 526 is in fluid communication with the chromatography column 580 while the second mixer 546 is in fluid communication with the sample loop 562. In the INJECT state, the first mixer 526 is in fluid communication the sample loop 562 and the sample loop 562 is in fluid communication with the chromatography column 580.

When in the LOAD state, the first mixer 526 can deliver a mixture of mobile phase and co-solvent to the column. In such embodiments, the mobile phase is delivered to the first mixer 526 from the mobile phase source 530 via the flow controller 532 and the co-solvent is delivered to the first mixer 526 from the first co-solvent source 522. When in the LOAD state, the second mixer 546 can deliver a mixture of mobile phase and co-solvent to the sample loop 562. In such embodiments, the mobile phase is delivered to the second mixer 546 from the mobile phase source 530 via the flow controller 532 and the co-solvent is delivered to the second mixer 546 from the second co-solvent source 542. The co-solvent from the second co-solvent source 542 can include a sample dissolved in the co-solvent. In other embodiments, the sample can be preloaded or injected into the sample loop 562. In some embodiments, the flow controller 532 and the second co-solvent source 542 can provide flow to the sample loop 562 until a pre-set pressure in the sample loop 562 is reached. For example, the pre-set pressure can be the same as the system pressure provided by the first co-solvent source 522 and the flow controller 532.

In other embodiments, continuous flow can be provided from the mixer 546 through the sample loop 562 in the LOAD state. In some of these embodiments, the valve 560 can be configured to place the sample loop 562 in communication with a gas/liquid separator 570 in the LOAD state. The gas/liquid separator is configured to separate the co-solvent or mixture of co-solvent and sample from the mobile phase, e.g., CO₂. In such embodiments, the gas liquid separator 570 can also be in fluid communication with the second co-solvent source 542. In other embodiments, flow from the mixer 546 through the sample loop 562 can pass to a waste container.

When in the INJECT state, the first mixer 526 can deliver a mixture of mobile phase and a co-solvent through the sample loop 562 to the column 580, injecting the contents of the sample loop 562 onto the column 580. When in the INJECT state, flow from the second mixer 546 can be directed to the gas liquid separator 570 or to waste.

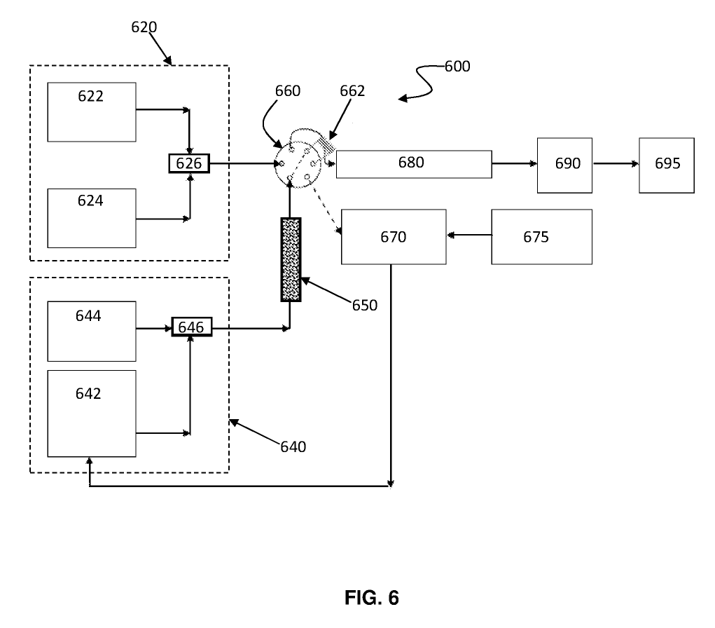

FIG. 6 illustrates another exemplary embodiment of a chromatography system 600. The system of FIG. 6 addresses combinations of sample, mobile phase and co-solvent in which the solubility of the sample in the mixture of mobile phase and co-solvent is higher than the solubility of the sample in pure co-solvent. The system of FIG. 6 also addresses the typical limitation of an SFC/highly compressible fluid chromatography system where the sample is introduced through the co-solvent stream. In a typical operation, the co-solvent stream is the only vessel to introduce sample into the system. If the co-solvent percent in the mobile phase is low, sample introduction can be significantly affected, resulting into either much lower concentration of sample in the mobile phase compared to the solubility limit, and/or much longer sample introduction time which may result into bad peak shapes and reduce yield. With such combinations of (a) sample, (b) mobile phase and (c) co-solvent, a chromatography system can be limited by the solubility of the sample in the co-solvent alone. This concentration of dissolved sample can be lower than the concentration of sample that would dissolve in the mixture of mobile phase and co-solvent. In other words, the system may only be capable of operating at less than the maximum productivity limit, i.e., with less than the maximum amount of sample dissolved in the mixture of sample, mobile phase and co-solvent that passes through the column. To address these issues, the exemplary system of FIG. 6 includes an extraction vessel 650 containing sample material through which the initial mixture of sample, mobile phase and co-solvent passes. As the mixture of sample, mobile phase and co-solvent passes through the extraction vessel 650, additional sample becomes dissolved up to the solubility limit of the mixture.

The system can include a first fluid delivery system 620 and a second fluid delivery system 640, each having a respective mobile phase source 624, 644, as discussed with respect to FIG. 4. In alternate embodiments, the system can include a single mobile phase source that can provide mobile phase to a first mixer and a second mixer, as discussed above with respect to FIG. 5.

As discussed above with respect to FIGS. 4 and 5, the relative concentrations of co-solvent and mobile phase provided by each fluid delivery system or mixer can be the same or different. For example, the relative concentrations of co-solvent and mobile phase provided by the first fluid delivery system 620 can be the same as the relative concentrations of co-solvent and mobile phase provided by the second fluid delivery system 640. In other embodiments, the relative concentrations of co-solvent and mobile phase provided by the first fluid delivery system 620 can be different from the relative concentrations of co-solvent and mobile phase provided by the second fluid delivery system 640. For example, the concentration of co-solvent provided by the second fluid delivery system 640 can be higher than the concentration of co-solvent provided by the first fluid delivery system 620. In some embodiments, the relative concentrations of co-solvent and mobile phase provided by one or both of the first fluid delivery system 620 and the second fluid delivery system 640 can be variable over an elution period or fraction thereof.

The system 600 also includes a valve 660, and a chromatography column 680. The valve 660 can include or be in fluid communication with a sample loop 662. In some embodiments, a detector 690 and a back pressure regulator 695 can be downstream of the column 680. Another optional component is a gas/liquid separator 670 or some other recovery/collection/recycling mechanism.

In embodiments in which the system includes first and second fluid delivery systems, the first fluid delivery system 620 can include a first co-solvent source 622, a first mobile phase source 624 and a first mixing connector 626. The second fluid delivery system 640 can include a second co-solvent source 642, a second mobile phase source 644 and a second mixing connector 646. The second co-solvent source 642 can be the sample source. For example, the second co-solvent source can provide co-solvent and a sample dissolved in the co-solvent. In some embodiments, especially ones lacking an optional gas/liquid separator 670, the second co-solvent source 642 is free of sample or feed material.

In embodiments in which the system includes a single mobile phase source, as in FIG. 5, the mobile phase source can provide mobile phase to a first mixing connector and a second mixing connector, e.g., via a flow controller. In such embodiments, the system can also include a first co-solvent source, a second co-solvent source. The first co-solvent source can be in fluid communication with the first mixing connector. The second co-solvent source can be in fluid communication with the second mixing connector.

As discussed above, the system 600 also includes an extraction vessel 650. The extraction vessel 650 can be in fluid communication with the second fluid delivery system 640 and with the valve 660. The extraction vessel 650 can, for example, contain a composition that includes the same sample material as the sample dissolved in the co-solvent of co-solvent source 642. In some embodiments, the sample can be stored within a suitable matrix. By including the extraction vessel 650 after the second mixing connector 646, one can potentially increase or maximize the solubility of a desired sample in the mixed mobile phase. That is, the solubility of the sample is not confined or strained by a co-solvent concentration alone. A second opportunity to increase sample solubility (e.g., saturate) occurs after the mixing of the mobile phase fluid (e.g., CO₂) and the co-solvent with sample dissolved therein. At the location of the extraction vessel 650, the concentration of sample that is dissolved can potentially be increased due to the presence of the mobile phase. In certain embodiments in which the second co-solvent source 642 does not contain any dissolved sample therein , the extraction vessel 650 is used to supply the sample to the system 600.

The valve 660 can be a multi-port rotary shear seal valve having a plurality of fluidic ports and one or more flow-through conduits. Although described primarily as a rotary valve, other types of suitable valves can also be used including, but not limited to, slider valves, solenoids, and pin valves. Each flow-through conduit provides a pathway between a pair of neighboring fluidic ports. When the valve rotates, its flow-through conduits move clockwise or counterclockwise, depending upon the valve's direction of rotation. This movement operates to switch the flow-through conduit to a different of neighboring fluidic ports, establishing a fluidic pathway between that different pair while removing the pathway from the previously connected pair of fluidic ports.

The valve 660 can be placed in a plurality of discrete positions. For example, those positions can include a first position corresponding to a LOAD state of the valve and a second position corresponding to an INJECT state of the valve. In the LOAD state, the first fluid delivery system 620 is in fluid communication with the chromatography column 680 while the second fluid delivery system 640 is in fluid communication with the sample loop 660 through the extraction vessel 650. In the INJECT state, the first fluid delivery system 620 is in fluid communication the sample loop 662 and the sample loop 662 is in fluid communication with the chromatography column 680.

When in the LOAD state, the first fluid delivery system can deliver mobile phase or a mixture of mobile phase and a co-solvent to the column. In such embodiments, the first fluid delivery system can include a first co-solvent source 622 and a first mobile phase source 624. When in the LOAD state, the second fluid delivery system 640 can deliver co-solvent or a mixture of co-solvent and a sample dissolved therein to the sample loop 662. In exemplary embodiments, the second fluid delivery system 640 can provide continuous flow through extraction vessel 650 and the sample loop 662 in the LOAD state. In such embodiments, the valve 660 can be configured to place the sample loop 662 in communication with a gas/liquid separator 670 in the LOAD state. The gas/liquid separator is configured to separate the co-solvent or mixture of co-solvent and sample from the mobile phase, e.g., CO₂. In such embodiments, the gas liquid separator 670 can be in fluid communication with the second fluid delivery system 640, e.g., with the second co-solvent source 642. The system 600 can also include a makeup fluid source 675 configured to provide co-solvent to the ensure that precipitated sample in the gas liquid separator is re-dissolved and washed back to the second fluid delivery system 640. In other embodiments, flow from the second fluid delivery system 640 through the sample loop 662 can pass to a waste container.

When in the INJECT state, the first fluid delivery system delivers mobile phase or a mixture of mobile phase and a co-solvent through the sample loop to the column, injecting the contents of the sample loop onto the column. When in the INJECT state, flow from the second fluid delivery system 640 can be directed to the gas liquid separator 670 or to waste.

One of ordinary skill in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

1. A chromatography system, comprising:
a first fluid delivery system including a first co-solvent source and a first mobile phase source;
a second fluid delivery system including a second co-solvent source and a second mobile phase source;
a sample loop;
a chromatography column; and
a valve, the valve having a plurality of discrete positions forming different fluidic connections including (i) a first position in which the first fluid delivery system is in fluid communication with the chromatography column and the second fluid delivery system is in fluid communication with the sample loop and (ii) a second position in which the first fluid delivery system is in fluid communication with the sample loop and the sample loop is in fluid communication with the chromatography column.

2. The chromatography system of claim 1, wherein the second co-solvent source provides a co-solvent and a sample dissolved in the co-solvent.

3. The chromatography system of claim 1, wherein the relative concentrations of co-solvent and mobile phase provided by the first fluid delivery system is the same as the relative concentrations of co-solvent and mobile phase provided by the second fluid delivery system.

4. The chromatography system of claim 1, wherein the relative concentrations of co-solvent and mobile phase provided by the first fluid delivery system is different from the relative concentrations of co-solvent and mobile phase provided by the second fluid delivery system.

5. The chromatography system of claim 4, wherein the concentration of co-solvent provided by the second fluid delivery system is higher than the concentration of co-solvent provided by the first fluid delivery system.

6. The chromatography system of claim 1, wherein the relative concentrations of co-solvent and mobile phase provided by one or both of the first fluid delivery system and the second fluid delivery system are variable over an elution period or fraction thereof.

7. The chromatography system of claim 1, wherein the mobile phase is CO₂.

8. The chromatography system of claim 7, wherein the CO₂ is in a supercritical state or a substantially supercritical state.

9. The chromatography system of claim 1, wherein the co-solvent is an organic solvent selected from the group consisting of: methanol, ethanol, isopropanol, acetonitrile, acetone, tetrahydrofuran, and mixtures thereof.

10. The chromatography system of claim 1, further comprising a gas liquid separator, wherein the second fluid delivery system is in fluid communication with the gas liquid separator through the valve in one or both of the first and second valve positions.

11. A chromatography system, comprising:
a first co-solvent source in fluid communication with a first mixer;
a second co-solvent source in fluid communication with a second mixer;
a mobile phase source configured to provide mobile phase to the first and second mixers;
a sample loop;
a chromatography column; and
a valve, the valve having a plurality of discrete positions forming different fluidic connections including (i) a first position in which the first mixer is in fluid communication with the chromatography column and the second mixer is in fluid communication with the sample loop and (ii) a second position in which the first mixer is in fluid communication with the sample loop and the sample loop is in fluid communication with the chromatography column.

12. The chromatography system of claim 11, wherein the second co-solvent source provides a co-solvent and a sample dissolved in the co-solvent.

13. The chromatography system of claim 11, wherein the relative concentrations of co-solvent and mobile phase from the first mixer is the same as the relative concentrations of co-solvent and mobile phase from the second mixer.

14. The chromatography system of claim 11, wherein the relative concentrations of co-solvent and mobile phase from the first mixer is different from the relative concentrations of co-solvent and mobile phase from the second mixer.

15. The chromatography system of claim 14, wherein the concentration of co-solvent from the second mixer is higher than the concentration of co-solvent from the first mixer.

16. The chromatography system of claim 11, wherein the relative concentrations of co-solvent and mobile phase from one or both of the first mixer and the second mixer are variable over an elution period or fraction thereof.

17. The chromatography system of claim 11, wherein the mobile phase is CO₂.

18. The chromatography system of claim 17, wherein the CO₂ is in a supercritical state or a substantially supercritical state.

19. The chromatography system of claim 11, wherein the co-solvent is an organic solvent selected from the group consisting of: methanol, ethanol, isopropanol, acetonitrile, acetone, tetrahydrofuran, and mixtures thereof.

20. The chromatography system of claim 11, further comprising a gas liquid separator, wherein the second mixer is in fluid communication with the gas liquid separator through the valve in one or both of the first and second valve positions.

21-28. (canceled)
